(19) United States
(12) Patent Application Publication
(10) Pub. No.: US 2017/0252980 A1
(43) Pub. Date: Sep. 7, 2017

(54) MULTI-LAYER SHEET HAVING FUNCTIONAL SURFACES FOR USE ON A 3-D PRINTER AND RELATED METHODS

(71) Applicant: Shawsheen Rubber Co., Inc., Andover, MA (US)

(72) Inventors: Denis J. Kelley, Lynnfield, MA (US); Timothy Kowal, Windsor, CT (US); Gary Litman, Framingham, MA (US); Jonathan G. McEuen, Winchester, MA (US)

(21) Appl. No.: 15/244,266

(22) Filed: Aug. 23, 2016

Related U.S. Application Data
(60) Provisional application No. 62/303,026, filed on Mar. 3, 2016.

(51) Int. Cl. B29C 67/00; B32B 7/06; B32B 27/32; B32B 5/02; B32B 5/18; B33Y 30/00; B32B 7/12

(52) U.S. Cl. CPC B29C 67/0092; B29C 67/0055; B33Y 30/00; B32B 7/06; B32B 7/12; B32B 5/022; B32B 5/18; B32B 27/32; B32B 2255/26

(57) ABSTRACT

A multi-layer sheet for use with a three-dimensional printer platform includes an intermediate layer, a polymer receptive coating disposed on one side of the intermediate layer, and a pressure sensitive adhesive disposed on an opposite side of the intermediate layer. The three-dimensional printer includes a platform, a printer head that deposits material to form a product while at least one of the platform and printer head are moved. The multi-layer is sheet disposed on the platform upon which the product is formed with the product formed on the polymer receptive coating, and the pressure sensitive adhesive contacting the platform.

### CROSS-REFERENCE TO RELATED APPLICATIONS

This application claims priority of U.S. Provisional Application Ser. No. 62/303,026 filed Mar. 3, 2016, which is incorporated herein by reference.

### TECHNICAL FIELD

This invention relates generally to an engineered, multi-layer sheet used in the process of three-dimensional printing (also known as “additive manufacturing”). More particularly, the present invention relates to a multi-layer sheet for use with 3D printers of the type utilizing polylactic acid (PLA) or acrylonitrile butadiene styrene (ABS) as the filament or extrudate. Specifically, the invention provides a multi-layer sheet having two functional surfaces, one surface for holding the sheet in place on the 3D printer, and the other surface for temporarily retaining and holding in position the 3D product while it is being produced by the 3D printer. Notably, the multi-layer sheet can then be removed cleanly from the product and the printer at the end of the printing process.

### BACKGROUND FOR THE INVENTION

The current state of the art in additive manufacturing/3D printing involves the non-specific use of commercially available tape products that are capable of acting as covers for the bed/platen/gantry/receiving surface of 3D printers, but simply are not developed for that use. In fact, there is currently no common knowledge or standard in the industry as to what type of tape or sheet product works best for retaining and holding an extrudate of a 3D product being printed. Nevertheless, this is a serious problem for 3D printers.

Heretofore, essentially any typical commercially available retail tape designed for purposes and uses wholly unrelated to retaining 3D printed products on the bed, platen, gantry or receiving surface of the printer have been used. The tape or any other sheet product is used primarily to maintain the bed or receiving surface as clean as possible for subsequent uses. One common example is the blue-colored “painter's tape” manufactured by and commercially available from 3M and others. However, simply by its name, it will be understood that this tape is designed for painters, not printers. Furthermore, such tape is commonly not sold at a wide enough width to cover the entire platen/gantry of a 3D printer. Accordingly, oftentimes, multiple strips of tape are used side-by-side to provide the width necessary to cover the platen/gantry. Alternatively, some consumers buy several meters of wide rolls of similar tape products and then have to cut the tape product to a size that will cover the platen/gantry of their particular 3D printer. However, this coverage issue still does not address the problem of adhesion of the extrudate.

As the problem of adhesion of 3D printed products to the bed/platen/gantry of a 3D printers has become more common, many people have searched for a solution. At present, there simply are no solutions that provide, on the one side or surface of the sheet, the capability of holding the covering itself in place on the 3D printer, while simultaneously, on the other side or surface, the capability of at least temporarily retaining and holding the 3D printing product in place during printing.

Various solutions for retaining the 3D printed product on the presently available commercial tapes include adjusting the bed temperature of the 3D printer, leveling the bed/platen/gantry of the 3D printer, adjusting the height and/or width of the first layer of printed product onto the bed/plate/gantry, cleaning the bed or the tape or re-taping the bed prior to use, slowing down the speed of the printing, adding a brim, or using a high grade plastic or polymer. Unfortunately, each of these solutions is inadequate for various reasons. It is often not possible to change the bed temperature or completely level the bed/platen/gantry of the 3D printer prior to or during printing. It is often undesirable to adjust the height and/or width of the first layer of the printed product or add a brim, and much more costly to use high grade polymers. Further, re-taping or adding a new cover is time consuming and must be done with care so as not to contaminate the surface. Also, not many tapes can be removed easily from the bed/platen/gantry of the 3D printer without a residue, making cleaning the surface necessary.

Thus, the need exists for a sheet that is both capable of maintaining its position on the bed/plate/gantry of the 3D printer, while also being capable of at least temporarily retaining and holding the product being printed on the 3D printer.

At present, Applicants are unaware of any patents related to the use of consumables in 3D printing and additive manufacturing that specifically address the problems noted above. Furthermore, the prior art in the industry provides no chemical, mechanical, or structural composition or performance product that meets the needs of the 3D printing industry.

For example, U.S. Patent Application Publication No. 2014/0138019 discloses sticking a film to a transparent sheet by removable glue and printing the 3D image on an inner surface of the film, the film then being molded into a 3D shape. The present invention does not use a film to be molded in accordance with the 3D image. Rather, the present invention is a consumable (i.e., throw-away after use) product sheet used to ensure consistent position and removability of the 3D printed product.

U.S. Pat. No. 5,939,008 discloses a flexible sheet substrate for mounting on the top surface of the modeling table in a 3D printer assembly, and also describes some characteristics of this sheet, such as that it can be made of polymeric material, or acrylic, and made with a thickness of approximately 0.06 inches. The patent also describes a “hold-down force” to keep the sheet retained on the modeling table. However, the patent does not describe a multiple-layered surface or constructed sheet with multiple individual components. Nor does it specify any hold-down force that is intrinsic to the sheet construction.

U.S. Pat. No. 7,127,309 is commonly cited by other patents in this area. This patent discloses multiple variations of a 3D printing machine with an interlocking modeling platform surface. This surface has a substrate which receives the filaments for producing the 3D printed product. Generally, the patent is directed to a reusable, modeling platform surface that includes a receiving substrate material comprised of “a substantially rigid, non-dusting tray providing a modeling surface.” The patent goes into detail on the qualities of the modeling surface, indicating that it is comprised of plastic and particularly molded plastic, that it has a surface texture, which may be rough or smooth, and that the surface texture may have a medium-coarse EDM finish. It will be appreciated that this patent provides a tray for the modeling surface, not a consumable product constructed to adhere to the tray.

Various other patents and published patent applications have noted the general use of flexible polymer films, coating, liner, tapes and trays or other substrates for adhering deposited material onto the platen or onto the build substrate of 3D printers. However, none of the patents or published patent applications suggest the use of a consumable sheet having the technical performance requirements that would not only hold the sheet itself to the platen, tray, or bed, but would also hold the 3D printed product at least temporarily, and then be capable of having the 3D printed product removed from it as well has being capable of removing it from the platen or tray.

### SUMMARY OF THE INVENTION

It will, therefore, be appreciated that the invention advantageously offers superior functional performance and differentiated structure to commonly used solutions to the issue of temporarily fixing the position of additive manufacturing products being produced. Specifically, when compared to tape products, which are not specifically designed for additive manufacturing surface platforms, such as, for example, the polyimide (Kapton®) tape commercially available from DuPont, or the blue “painter's tape” commercially available from 3M and others, the construction of the present invention provides superior capture of 3D printed objects, as shown in test data provided herein. This is due to the incorporation of textured materials such as woven and non-woven fabrics, flocked materials, and paper substrates, as well the coating of these substrates with polymer materials providing the optimal heat-mediated adhesion to 3D printed materials. Additionally, the present invention offers increased flexibility and accommodation of leveling 3D printers by nature of incorporating compressible (e.g., foam) layers which allow 3D printers to accurately deposit layers of viscous substrate materials even when base platform leveling is less than perfectly precise.

Compared to the generic “film,” “paper,” “polymer,” or otherwise-noted “sheets” in other prior art, the present invention is superior due to the incorporation of multiple different functional materials in the final construction. Specifically, the incorporation of textured materials (woven or nonwoven fabric, paper, or flocked materials) with foam padding provide greater functional capabilities than any singular construction discussed in prior art, and allows a wider functional range for 3D printers than is provided by singular sheets, polymer layers, or films. Additionally, the materials of the present invention are thicker than the constructions listed in prior art, with final thicknesses in the 0.09398 to 5.1054 mm range.

One aspect of the present invention is to provide a multi-layer sheet for use with a three-dimensional printer platform, comprising an intermediate layer, a polymer receptive coating disposed on one side of the intermediate layer, and a pressure sensitive adhesive disposed on an opposite side of the intermediate layer.

Another aspect of the present invention is to provide three-dimensional printer comprising a platform, a printer head that deposits material to form a product while at least one of the platform and the printer head are moved, and a multi-layer sheet disposed on the platform upon which the product is formed, the multi-layer sheet comprising an intermediate layer, a polymer receptive coating disposed on one side of the intermediate layer, wherein the product is formed on the polymer receptive coating, and a pressure sensitive adhesive disposed on an opposite side of the intermediate layer, wherein the pressure sensitive adhesive contacts the platform.

In one or more embodiments, yet another aspect of the present invention may be achieved by providing a precision-manufactured laminated sheet for use in additive manufacturing/3D printing to retain and hold the 3D printed product in position throughout the additive manufacturing process.

### BRIEF DESCRIPTION OF THE DRAWINGS

These and other features and advantages of the present invention will become better understood with regard to the following description, appended claims, and accompanying drawings wherein:

FIG. 1 is a schematic representation of a 3D printer of the type suitable for use in accordance with the present invention;

FIG. 2 is an exploded view of a gantry portion of the 3D printer of FIG. 1 having a layered sheet embodying the concepts of the present invention positioned above a gantry of the 3D printer;

FIG. 3A is a cross-sectional view of a multi-layered sheet of the present invention;

FIG. 3B is a cross-sectional view of an alternative embodiment of the multi-layered sheet of the present invention;

FIG. 4A a cross-sectional view of another alternative embodiment of the multi-layered sheet of the present invention;

FIG. 4B is a cross-sectional view of yet another alternative embodiment of the multi-layered sheet of the present invention;

FIG. 5A is a cross-sectional view of still another alternative embodiment of the multi-layered sheet of the present invention; and

FIG. 5B is a cross-sectional view of a further alternative embodiment of the multi-layered sheet of the present invention.

### PREFERRED EMBODIMENTS FOR CARRYING OUT THE INVENTION

The present invention is directed to a precision-manufactured laminated sheet for use in additive manufacturing/3D (three-dimensional) printing to retain and hold a 3D printed product in position throughout the additive manufacturing process. The additive manufacturing process is conducted by using a 3D printer generally of the type utilizing polylactic acid (PLA) or acrylonitrile butadiene styrene (ABS) as the filament or extrudate resin. The sheets of the present invention have two functional surfaces, one surface for holding the sheet in place on the 3D printer, and the other surface for temporarily retaining and holding in position the 3D product while it is being produced on the 3D printer. Notably, the multi-layer sheet can then be removed cleanly with no residue at the end of the printing process.

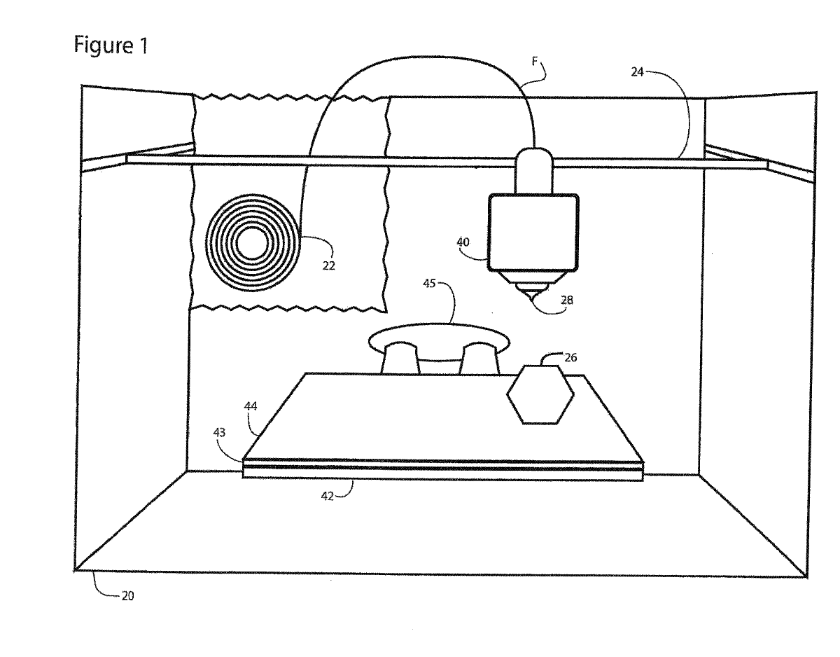

One representative embodiment of such a 3D printer, denoted generally by the numeral 20, is shown in FIG. 1. Generally, such a 3D printer 20 includes a substrate spool or reservoir 22 that provides filament or resin material (F) to a printer head 40 wherein the material is directed through a printing nozzle 28 and onto a platform 42 sometimes referred to as a gantry or a platen. The platform may include any platen or gantry known in the art. In the representative embodiment shown in FIG. 1, the platform 42 has a sheet 44 on its topside surface for use in maintaining the printed product on the platform 42 during the printing process. Above or below the platform 42 may be a further gantry heating/cooling platform 43 that may be used to heat and/or cool the platform 42 as desired. In other words, depending upon the end product and other manufacturing or operational parameters, the heating/cooling platform 43 may be heated and/or cooled during various stages of the printing process to facilitate manufacture of the product and to assist in removal of the finished product from the platform 42. It will further be appreciated that heating and/or cooling the platform 42 using the heating/cooling platform 43 may be based upon computer software parameters for the building of the 3D printed product. Moreover, the software parameters, in combination with the properties of the sheet 44, may help in maintaining the resultant printed product, such as product 26 in FIG. 1, on the cover sheet 44 during the printing process. It will be appreciated that the printed product 26 is produced by the movement of the printer head 40 as directed by computers (not shown) or other technology maintained by a printer head guide frame 24. As the printer head 40 is moved along the guide frame 24, substrate or filament F is forced out of the printer nozzle 28 and onto the sheet 44 covering the platform 42, wherein the filament F can be layered and built up to make the 3D printed product 26. In some embodiments the platform 42 may also be moved via a platform lift mechanism 45 operatively connected to the platform 42.

As noted above, the present invention is directed to the multi-layered sheet 44 that is used to cover the platform 42 to at least temporarily maintain the printed product 26 in place. The present invention provides for a sheet construction that prevents movement of the sheet on the platform 42, as well as prevents the printed product 26 from moving on the sheet.

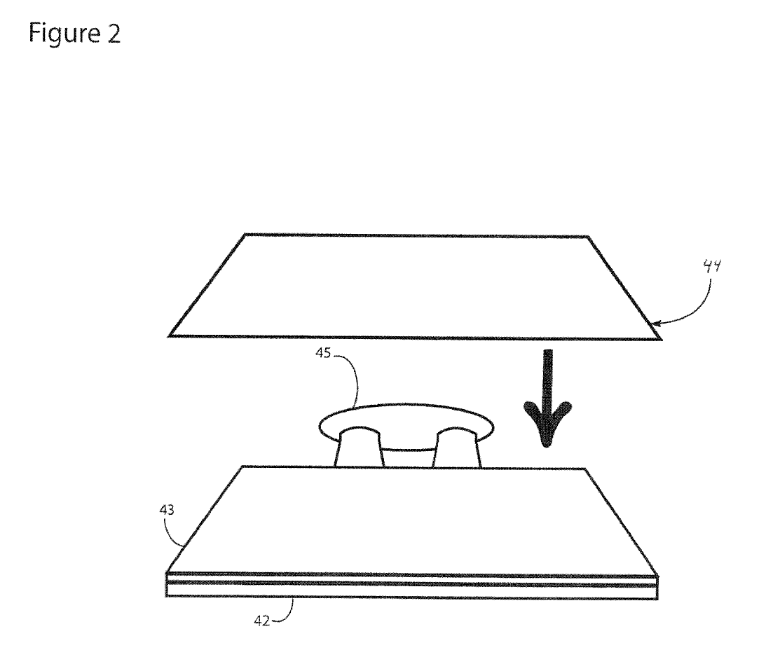

With reference to FIG. 2, the sheet's construction includes a bottom side (the base side) which is placed onto the platform 42 or platform 43 of the 3D printer 20. This bottom side may be coated with a non-silicone based pressure sensitive adhesive (PSA) 38 which can be removed from the platform 42 or platform 43 without leaving a residue. In one embodiment, the PSA is an acrylic adhesive system with adhesion strength under 2 pounds per linear inch (350.25 newtons per meter). Alternatively, the PSA may also be a synthetic rubber PSA of the cleanly removable type, with adhesion bond strength under 2 pounds per linear inch (350.25 newtons per meter). The sheet's composition may also include one or more layers of uniform material which serve to mechanically or chemically hold the substrate of additive manufacturing products in place. As used herein, the word “layer” is a substantially uniform thickness of a material that may be in any form as discussed below. A layer may have interstices or portions which are thicker than other nearby areas, but each layer is of a substantially planar configuration that may or may not be laminated to at least one other adjacent layer.

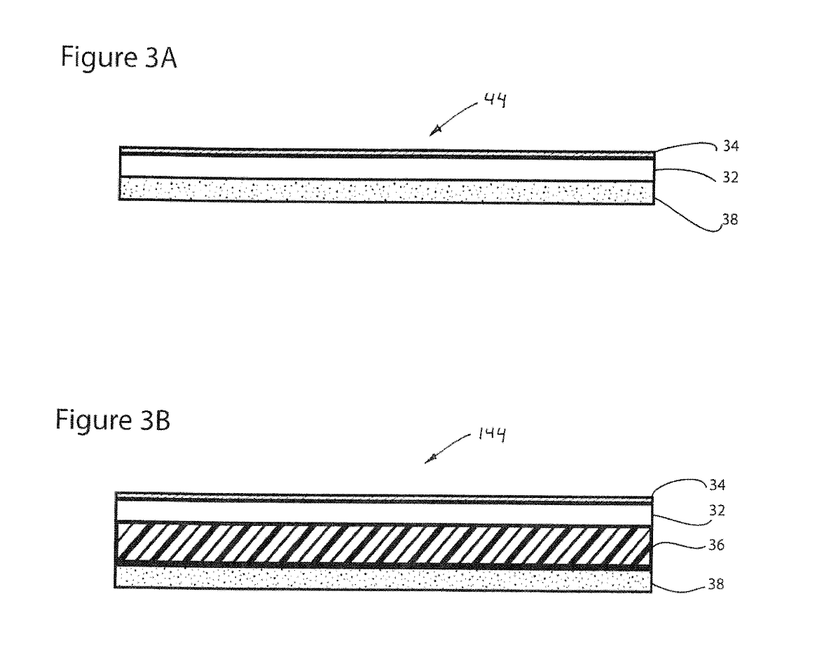

With reference to FIG. 3A, one embodiment of such a sheet 44 can be made from an intermediate layer which may be a substrate 32 selected from the group consisting of film, cloth, fabric, woven fabric, non-woven material and non-creped paper with or without padding. This construction includes the pressure-sensitive adhesive 38 being coated on one side of the substrate 32, which will be coated with a polymer receptive coating 34 on the other side to assist in holding substrate in an additive manufacturing/3D printing process. If cloth fabric is used as the substrate 32, it may be selected from cotton; a blend of cotton with polyester, rayon, or other polymer materials; and a completely polymer-based fabric. The polymer receptive coating 34 may be selected from acrylic, EVA, polyamide, polyester, polyurethane, and PVA. In some embodiments the polymer receptive coating may be acrylic.

As noted above and as seen in FIG. 3B, the construction of a sheet 144, which includes the layers of the sheet 44, may further include a layer of compressible padding 36 material between the pressure-sensitive adhesive 38 and the substrate 32. The padding 36 is used to provide cushion and accommodation for the gap between 3D printer nozzle 28 and the platform 42 used in the additive manufacturing process. The compressible padding 36 may be constructed from any material selected from closed cell polyolefin foam and other known compressible materials, electrostatically flocked fabric, film, paper, or other web substrate, felt, non-woven fabric, woven fabric, and other compressible foam materials. The padding 36 is believed beneficial in absorbing any sudden changes in directions of the nozzle and/or printed product during the printing process. The padding may also vertically stabilize the product during printing.

Alternatively, in either sheet 44 or 144, the coated substrate 32 may be flat paper. The sheet 44 or 144 may or may not also be combined with a compressible padding layer 36 adjacent to the pressure-sensitive adhesive coating 38, as described above. In either embodiment above, the PSA 38 may be applied as a spray adhesive, as liquid glue or as a double-faced tape. Further, in either embodiment above, a release liner may be applied to the PSA 38.

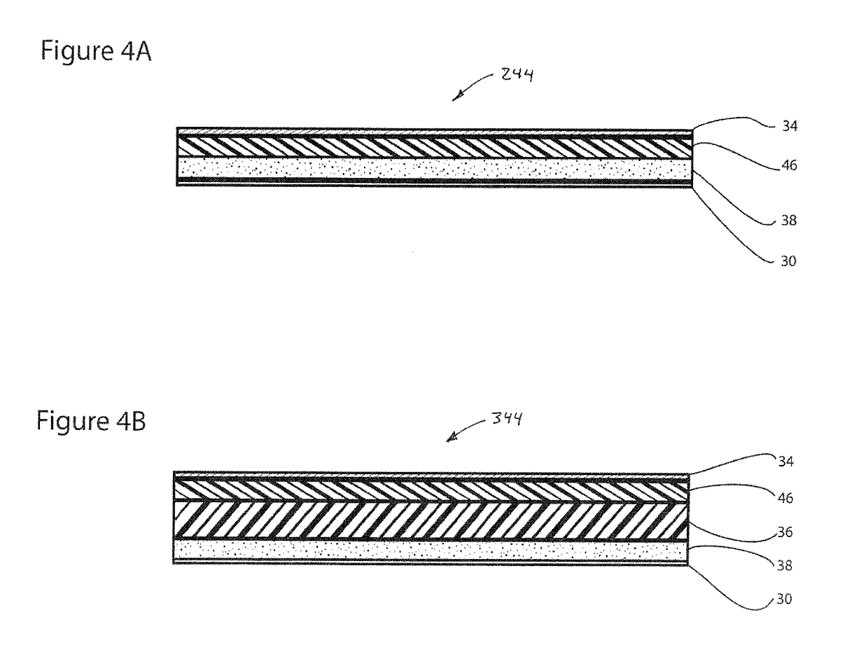

With reference to FIG. 4A, another embodiment of the sheet of the present invention can be made from a non-woven or woven fusible material with or without padding. In FIG. 4A, a sheet of this configuration is designated generally by the numeral 244. The construction of sheet 244 includes the pressure-sensitive adhesive 38 being bonded on one side to an intermediate layer such as a layer of non-woven or fusible material 46. Disposed on one side of the material 46 is the polymer receptive coating 34. Coacting together, the coating 34 and the material 46 provide the sheet 244 with the chemical structure and heat reactivity characteristics to act as a heat-sealable thermoplastic surface to assist in holding printing product 26 in an additive manufacturing/3D printing process. In other words, the heat of the filament or resin material exiting the nozzle 28 and/or the heat from the heating/cooling platform 43 may cause the material 46 and the material of the polymer receptive coating 34 to work in concert to hold the 3D print material to the sheet and, as a result, the platform. The material 46 and the print material undergo a thermoplastic or bonding reaction, while the print material and the receptive coating material 34 undergo a chemical reaction. The coating material 34 is thin enough to not substantively interfere with the controlled bonding of the product 26 and the material 46 in view of heat transferring through the coating. This coaction may be assisted by heat from the heating/cooling platform 43. Skilled artisans will further appreciate that the bond between the material 46 and print material is sufficient to hold the product during the printing process but still allow separation of the material from the product, without damaging the product, when printing is completed. Skilled artisans will appreciate that the sheet 244 may be prepared with just the PSA attached and without padding, and with or without a release liner 30 attached to the PSA before use on the platform 42 of the 3D printer 20.

In another embodiment and as shown in FIG. 4B, a sheet, which is configured much like the sheet 244 is designated by the numeral 344, may further include the compressible padding layer 36 between an intermediate layer of the non-woven or woven fusible material 46 and the PSA 38, with or without a release liner 30 attached to the PSA 38 prior to use on a 3D printer 20.

The non-woven or woven fusible material 46 may be selected from EVA, polyamide, polyester, polyethylene, polyolefin, polyurethane, urethane, PVA and any other thermoplastic, heat-sealable coating. In some embodiments, the non-woven or woven material is polyester.

Where there is a layer of padding material 36 between the pressure-sensitive adhesive 38 and the non-woven fusible material 46, it is used to provide cushion and accommodation for the 3D printer nozzle 40 in the additive manufacturing process. The compressible padding layer 36 may be constructed from closed cell polyolefin foam, electrostatically flocked fabric, film, paper, or other web substrate, felt, non-woven or woven fabric or other compressible foam materials. As in the prior embodiments, the PSA 38 in these embodiments may be applied as a spray adhesive, as liquid glue or as a double-faced tape.

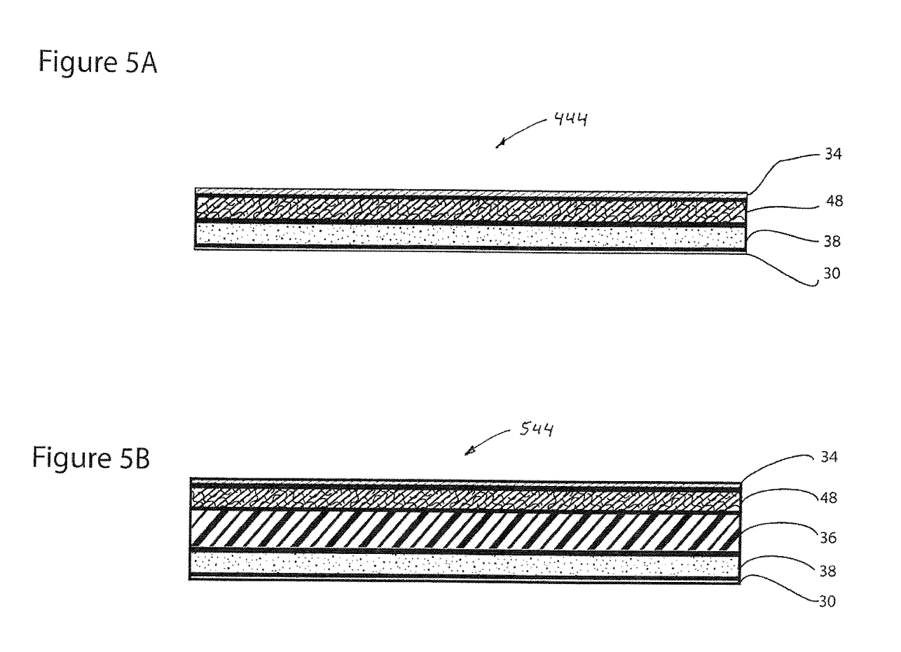

With reference to FIG. 5A, another embodiment of a sheet is designated generally by the numeral 444. The sheet 444 of the present invention can be made from an intermediate layer such as a flocked web material 48, with or without padding. As in the other embodiments, a polymer receptive coating 34 is positioned adjacent to and in touching contact with the material 48. The sheet 444 may include the pressure-sensitive adhesive being bonded to the opposite side of the flocked web material 48. Coacting together, the coating 34 and the flocked substrate/material 48 provide the chemical and physical structure characteristics to act as a surface to hold printed parts in an additive manufacturing/3D printing process, and to allow the removal of the 3D printed object 26 with a layer of flocked fabric incorporated into the printed platen 42 side of the object surface. In other words, the heat from the print material and the heat from the heating/cooling platform 43, if provided, allows the flocked material 48 to impart a micro-texture that physically grips or at least generates a sufficient frictional interface so as to maintain the printer material on the sheet during the printing process. Although the flock material 48 may also be heat reactive as in the previous embodiment, this is believed to be secondary to the physical texture effect. And the holding force still allows separation of the material 48 from the product, without damaging the product, when printing is completed.

The fiber flocking material 48 may be selected from cotton fibers, acrylic, polyamide fibers, polymeric microfibers, rayon fibers, and wool fibers. The flocked substrate can be a web material selected from EAA, EMA, EVA or other olefin, LDPE, MDPE or HDPE, non-woven fabrics, paper, PET, PVC, and woven fabrics.

In another embodiment shown in FIG. 5B, a sheet designated generally by the numeral 544 is shown. The sheet 544 is similar to the sheet 444, but further includes the padding layer 36 disposed between the layer of flocked web material 48 and the PSA 38 in a manner similar to the other embodiments.

In one or more embodiments, the flocking material 48 comprises flocked microfiber and flock adhesive cement (which may hold the flock material together). The material 48 may be water dissolvable. As with the other embodiments, the PSA 38 in these embodiments may also be a spray adhesive, liquid glue, or a double-faced tape. These embodiments may also include a release liner 30 that is applied to the PSA 38 which is to be removed upon application to the 3D printer 20.

It will be appreciated that the sheets of the present invention are manufactured specifically to the working surface of the platform, platen or gantry of the 3D printer being used in the additive manufacturing process. Thus, there is no cutting or multiple tape lines necessary for these sheets. Common platen sizes on retail 3D printer machines range from a common low-end of about 6 inches by 9 inches (15.24 cm by 22.86 cm) to a common higher end size of about 9 inches by 12 inches (22.86 cm by 30.48 cm). However, there are also very large commercially available build volumes having platforms of a size of about 24 inches by 24 inches (60.96 cm by 60.96 cm) as well. Beyond these very large size printers are industrial 3D printers, which now can print entire houses. But it will be appreciated that such industrial 3D printers ‘print’ with different materials than those set forth for this invention, including metals and other alloys. Thus, the present invention is typically used with the general retail and commercial 3D printers that employ well known types of resin filament, such as, but not limited to, PLA and ABS.

In order to demonstrate practice of the invention, sheets of the various embodiments of the present invention were prepared and tested against tapes currently used in the industry. The resultant tests demonstrate that the sheets of the present invention provide unique and superior performance.

To begin, sample patterns were acquired from an industrial 3D printer and were printed repeatedly with a common 3D printer machine commercially available to the public to minimize variable changes across multiple printings of similar patterns. Commonly-utilized workarounds in additive manufacturing (such as consumer painter's tape and film) were tested against the constructions/sheets in this disclosure, and the completeness and precision of 3D printed products were recorded.

The machinery used for all testing was an Imaginator 3D printing machine (sold by Halcraft USA, Mt. Vernon N.Y., and RNK Distributing, Knoxville, Tenn.). A standard 3D printer quality test—a 50 MM octopus print (available at http://www.thingiverse.com/thing:113158)—was used as a print which tests both fine application of resin and application of resin in small-scale curved patterns. To test printing performance against prints that involve rapid movement of the 3D printer head, a set of train tracks was also used as a test design.

To produce each 3D print test, the following steps were taken. The sheet construct was designed as a laboratory sample (involving laminating the substrate and backing layers, and applying any coating layers to produce the final test construct). After drying, the test sheet was applied by hand to the printer platen, which then levelled to within 1 mm of the test surface. The 3D printer was loaded with software to produce the test prints, and was allowed to start running the program from a cooled starting point. If the print showed complete breakage or failure, it was stopped. If the print was completed, the print was retained and labelled for records. After each print, the outcome of the process was recorded.

Table I provided below sets forth the results of each test.

TABLE I

| | Surface | | | |
|---|---|---|---|---|
| Substrate | Coating/Layer | Print | Resin | Outcome |
| Neenah Crepe | Neenah's highest | Octopus | PLA | Failure to grab resin - |
| paper 7895833 | temperature | | | PLA rolls off |
| | release coating | | | |
| Neenah Crepe | Neenah's highest | Octopus | PLA | Failure to grab resin - |
| paper 7895881 | temperature | | | PLA rolls off |
| | release coating | | | |
| Neenah Crepe | Neenah's highest | Octopus | PLA | Failure to grab resin - |
| paper 7895566 | temperature | | | PLA rolls off |
| | release coating | | | |
| Potsdam 700779 34 | No release | Octopus (2 tests) | PLA | Failure to grab resin - |
| Lb Blue Acrylic | coating | | | PLA rolls off |
| crepe | | | | |
| Potsdam 37561, 34 | No release | Octopus (2 tests) | PLA | Failure to grab resin - |
| Lb cream crepe | coating | | | PLA rolls off |
| Pink (Fibermark/ | High temperature | Octopus (printed | PLA | Unreliable - occasional |
| Neenah) crepe | release coating | on non-release | | success, occasional |
| paper) | | side) | | failure |
| Common white | No coating | Octopus | PLA | Excessive hold of paper |
| copy paper | | | | to 3D printed item; |
| | | | | difficult to remove |
| Common white | No coating | Train Tracks | PLA | Failure to hold initial |
| copy paper | | | | layers of print |
| Heavyweight copy | No coating | Octopus | PLA | Inconsistent; failure |
| paper | | | | from PLA not adhering, |
| | | | | wadding up on extruder |
| White copy paper | Polyester resin | Octopus | PLA | Failure- PLA wadded |
| | | | | up on extruder |
| Heavyweight copy | Polyester resin | Octopus | PLA | Failure- PLA wadded |
| paper | | | | up on extruder |
| Black Gaffers tape | | Octopus | PLA | Failure to hold resin on |
| fabric | | | | both sides of construct |
| Flocked microfiber | Coated finish | Octopus | PLA | Failed on both sides of |
| fabric | | | | construct material |
| Black Polyolefin | No Coating | Octopus | PLA | Failed - PLA dragged |
| non-woven (Hanes) | | | | around fabric surface |
| White Polyolefin | No Coating | Octopus | PLA | Failed - PLA dragged |
| non-woven (Hanes) | | | | around fabric surface |
| Heavyweight copy | Polyester | Octopus | PLA | Immediate failure |
| paper | | | | |
| Heavyweight copy | Urethane | Octopus | PLA | Immediate failure, |
| paper | | | | inconsistent failure |
| Parchment Paper | No coating | Octopus | PLA | Immediate failure to |
| | | | | hold |
| Parchment Paper | Silicone Release | Octopus | PLA | Immediate failure to |
| | | | | hold |
| Wax Paper | No coating | Octopus | PLA | Immediate failure to |
| | | | | hold |
| Non-woven heat | No coating | Octopus | PLA | Accepted resin, but hard |
| fusible | | | | to remove (causes |
| | | | | bending) |
| Nylon Non-Woven | No coating | Octopus | PLA | Printable |
| Nylon Non-Woven | No coating | Train Tracks | PLA | Failure after first layer |
| Fabric or film with | No coating | Octopus | PLA | Immediate failure to |
| rayon microfiber | | | | hold |
| flock | | | | |
| Fabric or film with | No coating | Octopus | PLA | No adherence to resin |
| cotton microfiber | | | | |
| flock | | | | |
| Fabric or film with | No coating | Octopus, Train | PLA | Printable, but left thick |
| nylon microfiber | | tracks | | microfiber resin |
| flock (.1, .2, .3 mm | | | | |
| length) | | | | |
| Fabric or film with | No coating | Octopus | PLA | Immediate failure to |
| polyester microfiber | | | | hold |
| flock | | | | |
| Dark Blue nylon | No release | Octopus | PLA | Adheres, shows |
| microfiber flock, | coating | | | degradation of |
| PET backing | | | | microfiber (flock |
| | | | | cement degrades); |
| | | | | tenting also seen |
| SAMPLE #1 | Nylon polymer, | Octopus, Train | PLA | Two train track prints |
| woven green | Polyamide | Tracks | | and 6 Octopus prints |
| polyester/cotton | | | | were produced with no |
| Cloth 1/32″ and | | | | sign of wear. |
| 1/16″ PE foam. | | | | |
| Removable PSA. | | | | |
| SAMPLE #2 | Nylon polymer, | Octopus | ABS | Accepted ABS resin, |
| woven fabric with | Polyamide | | | but permanently fused |
| heaver coating of | | | | to polyamide coating |
| the Polyamide, | | | | |
| laminated to a | | | | |
| 1/32″ thick PE | | | | |
| foam | | | | |
| SAMPLE #3 | Nylon polymer, | Octopus, Train | PLA | Consistently prints |
| fusible non-woven | Polyamide | Tracks | | |
| 1/32″ and 1/16″ PE | | | | |
| foam. Removable | | | | |
| PSA. | | | | |
| SAMPLE #4 | Nylon polymer, | Octopus, Train | PLA | Consistently prints |
| non-creped paper | Polyamide | Tracks | | |
| 1/32″ and 1/16″ PE | | | | |
| foam. Removable | | | | |
| PSA. | | | | |

As can be seen from TABLE I, all of the sample sheets of the present invention provide suitable printed products. However, almost all of the conventionally, non-specific use tapes, cloths and sheets currently used with commercial 3D printers failed even the octopus standard test. It is noted that a sheet of nylon non-woven did print the octopus successfully. However, when the same sheet was used to print the train tracks, it failed. Notably, the train tracks are harder to print, given that the computer program used to make the train tracks causes the printer head to move quickly and violently, which causes significantly more mechanical stress on the resin feed. Accordingly, if the sheet moves at all, it is likely to fail the test with the train tracks.

Thus it should be evident that a sheet of the present invention is highly effective in providing consistent prints by self-adhering the lower surface of the sheet to the platen/gantry of the 3D printer, while simultaneously holding the printed product or the resin filament that makes the printed product to its upper surface during the printed process. Further, the resultant 3D printed product can easily be removed from the sheet when completed, and the sheet is completely and cleanly removable from the 3D printer when desired. The sheet is consumable and easily replaceable.

In the embodiments presented, the total thickness of the sheets (not including the release liner) may vary between .0940 millimeter and 5.1054 millimeters, although other thicknesses may be used depending upon print materials and other printing parameters. As will be appreciated, the thicknesses of the various layers used in the different sheet embodiments may also vary depending upon the end use requirements. All embodiments use the PSA 38, which may have a thickness ranging from about 0.0254 to 0.0762 millimeters (mm), and the polymer receptive coating 34, which may have a thickness ranging from about 0.0051 to 0.0254 mm. None of the sheet thickness dimensions for the sheets described below include the release liner 30 which may have a thickness of about 0.0635 mm to 0.1785 mm.

For sheets 44 and 144 the substrate 32 may be various types of paper which have a thickness ranging from about 0.0635 to 0.2545 mm or various types of cloth which may have a thickness range of about 0.1524 to .3815 mm. As a result, the thickness of the sheet 44 may range from about 0.0940 mm to 0.4826 mm. When the compressible padding layer 36, which may have a thickness range from about 0.2540 mm to 1.5875 mm, is included in sheet 144, the thickness of the sheet may range from about 0.3480 mm to about 2.0701 mm.

For sheets 244 and 344, the substrate 46 may be various types of polymeric material which has a thickness ranging from about 0.0508 mm to 0.3810 mm. As a result, the thickness of the sheet 244 may range from about 0.0813 mm to 0.4826 mm. As such, when the compressible padding layer 36 is included in sheet 344, the total thickness may range from about 0.3353 mm to 2.070 mm.

For sheets 444 and 544 the flock material 48 may have a thickness ranging from about 0.3810 mm to 1.5875 mm. Accordingly, the thickness of sheet 444 may range from about 0.4115 mm to 1.6891 mm. When the compressible padding layer 36 is included in sheet 544, the thickness of the sheet may range from about 0.6655 mm to 3.2766 mm.

Again, the invention is particularly suited for use in 3D printers of the type utilizing PLA or ABS or other commonly used resins for additive manufacturing. Based upon the foregoing disclosure, it should now be apparent that the use of a sheet described herein will carry out the objects set forth hereinabove. Indeed, the various layers in any combination may be referred to as a sheet assembly and the positional relationship of the layers to one another may be switched or adjusted as needed. It is, therefore, to be understood that any variations evident fall within the scope of the claimed invention and thus, the selection of specific 3D printer, its operating conditions and the like, can be determined without departing from the spirit of the invention herein disclosed and described. Thus, the scope of the invention shall include all modifications and variations that may fall within the scope of the attached claims.

What is claimed is:

1. A multi-layer sheet for use with a three-dimensional printer platform, comprising:
an intermediate layer;
a polymer receptive coating disposed on one side of said intermediate layer; and
a pressure sensitive adhesive disposed on an opposite side of said intermediate layer.

2. The multi-layer sheet according to claim 1, wherein said polymer receptive coating is selected from the group consisting of acrylic, EVA, polyamide, polyester, polyurethane, and PVA.

3. The multi-layer sheet according to claim 1, wherein said polymer receptive layer is acrylic.

4. The multi-layer sheet according to claim 1, wherein said intermediate layer comprises:
a substrate selected from the group consisting of film, woven fabric, non-woven material, non-creped paper and cloth fabric, which may be selected from the group consisting of cotton, cotton blended with polyester, rayon, or other polymer materials, and polymer-based fabric.

5. The multi-layer sheet according to claim 4, further comprising:
a compressible padding layer disposed between said substrate and said pressure sensitive adhesive.

6. The multi-layer sheet according to claim 5, wherein said compressible padding layer is selected from the group consisting of closed cell polyolefin foam, electrostatically flocked fabric, film, paper, web-like substrates, felt, non-woven fabric, woven fabric, and compressible foam.

7. The multi-layer sheet according to claim 1, wherein said intermediate layer comprises a non-woven or fusible material disposed between said polymer coating and said pressure sensitive adhesive, wherein said non-woven or fusible material acts as a heat-sealable thermoplastic surface.

8. The multi-layer sheet according to claim 7, further comprising:
a compressible padding layer disposed between said non-woven or fusible material and said pressure sensitive adhesive.

9. The multi-layer sheet according to claim 8, wherein said compressible padding layer is selected from the group consisting of closed cell polyolefin foam, electrostatically flocked fabric, film, paper, web-like substrates, felt, non-woven fabric, woven fabric, and compressible foam.

10. The multi-layer sheet according to claim 1, wherein said intermediate layer comprises a flocked web material disposed between said substrate and said pressure sensitive adhesive, wherein said flocked web material provides chemical or physical characteristics.

11. The multi-layer sheet according to claim 10, further comprising:
a compressible padding layer disposed between said flocked web material and said pressure sensitive adhesive.

12. The multi-layer sheet according to claim 11, wherein said compressible padding layer is selected from the group consisting of closed cell polyolefin foam, electrostatically flocked fabric, film, paper, web-like substrates, felt, non-woven fabric, woven fabric, and compressible foam.

13. The multi-layer sheet according to claim 1, wherein said pressure sensitive adhesive is either an acrylic or a synthetic rubber which has an adhesion bond strength under 2 pounds per linear inch.

14. The multi-layer sheet according to claim 1, further comprising:
a release liner disposed on said pressure sensitive adhesive.

15. A three-dimensional printer comprising:
a platform;
a printer head that deposits material to form a product while at least one of said platform and said printer head are moved; and
a multi-layer sheet disposed on said platform upon which the product is formed, said multi-layer sheet comprising:
an intermediate layer;
a polymer receptive coating disposed on one side of said intermediate layer, wherein the product is formed on said polymer receptive coating; and
a pressure sensitive adhesive disposed on an opposite side of said intermediate layer, wherein said pressure sensitive adhesive contacts said platform.

16. The three-dimensional printer according to claim 15, wherein said intermediate layer comprises:
a substrate selected from the group consisting of film, woven fabric, non-woven material, non-creped paper and cloth fabric, which may be selected from the group consisting of cotton, cotton blended with polyester, rayon, or other polymer materials, and polymer-based fabric.

17. The three-dimensional printer according to claim 16, wherein said multi-layer sheet further comprises:
a compressible padding layer disposed between said substrate and said pressure sensitive adhesive, wherein said compressible padding layer is selected from the group consisting of closed cell polyolefin foam, electrostatically flocked fabric, film, paper, web-like substrates, felt, non-woven fabric, woven fabric, and compressible foam.

18. The three-dimensional printer according to claim 15, wherein said intermediate layer comprises a non-woven or fusible material disposed between said polymer coating and said pressure sensitive adhesive, wherein said non-woven or fusible material acts as a heat-sealable thermoplastic surface.

19. The three-dimensional printer according to claim 18, a compressible padding layer disposed between said non-woven or fusible material and said pressure sensitive adhesive, wherein said compressible padding layer is selected from the group consisting of closed cell polyolefin foam, electrostatically flocked fabric, film, paper, web-like substrates, felt, non-woven fabric, woven fabric, and compressible foam.

20. The three-dimensional printer according to claim 15, wherein said intermediate layer comprises a flocked web material disposed between said substrate and said pressure sensitive adhesive, wherein said flocked web material provides chemical or physical characteristics.

21. The three-dimensional printer according to claim 20, a compressible padding layer disposed between said flocked web material and said pressure sensitive adhesive, wherein said compressible padding layer is selected from the group consisting of closed cell polyolefin foam, electrostatically flocked fabric, film, paper, web-like substrates, felt, non-woven fabric, woven fabric, and compressible foam.
